(19) United States
(12) Patent Application Publication
(10) Pub. No.: US 2016/0056469 A1
(43) Pub. Date: Feb. 25, 2016

(54) POSITIVE ELECTRODE FOR NONAQUEOUS ELECTROLYTE SECONDARY BATTERY, METHOD FOR MANUFACTURING POSITIVE ELECTRODE FOR NONAQUEOUS ELECTROLYTE SECONDARY BATTERY, AND NONAQUEOUS ELECTROLYTE SECONDARY BATTERY

(71) Applicant: SANYO ELECTRIC CO., LTD., Osaka (JP)

(72) Inventors: Akihiro Kawakita, Hyogo (JP); Takeshi Ogasawara, Hyogo (JP)

(73) Assignee: SANYO ELECTRIC CO., LTD., Daito-shi, Osaka (JP)

(21) Appl. No.: 14/780,255

(22) PCT Filed: Mar. 25, 2014
(86) PCT No.: PCT/JP2014/001693

§ 371 Date: Sep. 25, 2015

(30) Foreign Application Priority Data
Mar. 28, 2013 (JP) 2013-067829

(51) Int. Cl. H01M 4/62; H01M 4/04; H01M 10/052

(52) U.S. Cl. CPC H01M 4/62; H01M 10/052; H01M 4/0416; H01M 2004/028

(57) ABSTRACT

A positive electrode for a nonaqueous electrolyte secondary battery, the positive electrode being configured so that even if the potential of the positive electrode is set to a high potential, degradation of cycle characteristics is suppressed. A positive electrode for a nonaqueous electrolyte secondary battery, which has a positive electrode plate in which a positive electrode mixture layer containing a positive electrode active material which occludes and releases Li, a binder, and an electrically conductive agent is formed on a positive electrode collector, and in this positive electrode, a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

### TECHNICAL FIELD

The present invention relates to a positive electrode for a nonaqueous electrolyte secondary battery, a method for manufacturing a positive electrode for a nonaqueous electrolyte secondary battery, and a nonaqueous electrolyte secondary battery using the positive electrode for a nonaqueous electrolyte secondary battery.

### BACKGROUND ART

In recent years, reduction in size and weight of mobile information terminals, such as a mobile phone, a notebook personal computer, and a smart phone, has been rapidly progressed, and as a result, batteries used as drive power sources thereof are further required to achieve an increase in capacity. Since having a high energy density and a high capacity, a lithium ion battery which performs charge/discharge by movement of lithium ions between a positive electrode and a negative electrode in synchronous with charge/discharge has been widely used as a drive power source of the mobile information terminals as described above.

In the mobile information terminals described above, in association with enhancement of functions, such as a movie reproduction function and a game function, the consumption electric power tends to further increase, and in order to realize long-term reproduction, improvement in output, and the like, the lithium ion battery functioning as a drive power source is further strongly requested to achieve an increase in capacity and an improvement in performance. As a method to increase the capacity of a nonaqueous electrolyte secondary battery, such as the lithium ion battery as described above, besides measures to increase the capacity of an active material and measures to increase a filling amount of an active material per unit volume, there may also be measures to increase a charge voltage of a battery. However, when the charge voltage of a battery is increased, a reaction between a positive electrode active material and a nonaqueous electrolyte solution is liable to occur.

For example, Patent Documents 1 and 2 have disclosed that when the surface of the positive electrode active material is covered with a compound, for example, even if the charge voltage of the battery is increased, the reaction between the positive electrode active material and the nonaqueous electrolyte solution can be suppressed.

However, even when the potential of the positive electrode is set to a high potential using the technique as disclosed in Patent Document 1 or 2, degradation of cycle characteristics may not be suppressed in some cases.

### CITATION LIST

### Patent Document

Patent Document 1: International Publication No. WO2005/008812

Patent Document 2: Japanese Published Unexamined Patent Application No. 2012-252807

### SUMMARY OF INVENTION

### Technical Problem

An object of the present invention is to provide a positive electrode for a nonaqueous electrolyte secondary battery, the positive electrode being configured so that even if the potential of the positive electrode is set to a high potential, degradation of cycle characteristics is suppressed; a method for manufacturing a positive electrode for a nonaqueous electrolyte secondary battery; and a nonaqueous electrolyte secondary battery using the above positive electrode for a nonaqueous electrolyte secondary battery.

### Solution to Problem

The present invention provides a positive electrode for a nonaqueous electrolyte secondary battery, the positive electrode comprising a positive electrode plate in which a positive electrode mixture layer containing a positive electrode active material which occludes and releases Li, a binder, and an electrically conductive agent is formed on a positive electrode collector, and in this positive electrode, a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

In addition, the present invention provides a method for manufacturing a positive electrode for a nonaqueous electrolyte secondary battery, the method comprising: bringing a positive electrode plate in which a positive electrode mixture layer containing a positive electrode active material which occludes and releases Li, a binder, and an electrically conductive agent is formed on a positive electrode collector into contact with a solution containing at least one element selected from W, Al, Mg, Ti, Zr, and a rare earth element so that a compound containing at least one element selected from W, Al, Mg, Ti, Zr, and a rare earth element is adhered to all surface of at least a part of the positive electrode active material, at least a part of the binder, and at least a part of the electrically conductive agent, each of which is contained in the positive electrode mixture layer.

Furthermore, the present invention provides a nonaqueous electrolyte secondary battery comprising: a positive electrode, a negative electrode, and a nonaqueous electrolyte. In this nonaqueous electrolyte secondary battery described above, the positive electrode includes a positive electrode plate in which a positive electrode mixture layer containing a positive electrode active material which occludes and releases Li, a binder, and an electrically conductive agent is formed on a positive electrode collector, and a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

### Advantageous Effects of Invention

The present invention provides a positive electrode for a nonaqueous electrolyte secondary battery, the positive electrode being configured so that even if the potential of the positive electrode is set to a high potential, the degradation of cycle characteristics is suppressed; a method for manufacturing a positive electrode for a nonaqueous electrolyte secondary battery; and a nonaqueous electrolyte secondary battery using the positive electrode for a nonaqueous electrolyte secondary battery described above.

### DESCRIPTION OF EMBODIMENT

Hereinafter, an embodiment of the present invention will be described. This embodiment is one example for carrying out the present invention, and the present invention is not limited to this embodiment.

### <Nonaqueous Electrolyte Secondary Battery>

A nonaqueous electrolyte secondary battery according to an embodiment of the present invention includes a positive electrode, a negative electrode, and a nonaqueous electrolyte. Although having the structure in which for example, an electrode body formed by winding or laminating a positive electrode and a negative electrode with at least one separator interposed therebetween and a nonaqueous electrolyte which is a liquid nonaqueous electrolyte are received in a battery exterior package can, the nonaqueous electrolyte secondary battery according to this embodiment is not limited thereto. Hereinafter, individual constituent members of the nonaqueous electrolyte secondary battery will be described in detail.

### [Positive Electrode]

The positive electrode for a nonaqueous electrolyte secondary battery according to the embodiment of the present invention includes a positive electrode plate in which a positive electrode mixture layer containing a positive electrode active material which occludes and releases Li, a binder, and an electrically conductive agent is formed on a positive electrode collector, and a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

Since the compound containing at least one element selected from W, Al, Mg, Ti, Zr, and a rare earth element is adhered to all the surfaces of at least a part of the positive electrode active material, at least a part of the binder, and at least a part of the electrically conductive agent, a decomposition reaction of the nonaqueous electrolyte can be suppressed not only on the surface of the positive electrode active material but also on the surfaces of the binder and the electrically conductive agent, each of which is adhered to the surface of the positive electrode active material. Hence, it is believed that even if the potential of the positive electrode is set to a high potential, the degradation of cycle characteristics is suppressed, and excellent cycle characteristics can be obtained.

In the positive electrode for a nonaqueous electrolyte secondary battery according to this embodiment, the compound containing at least one element selected from W, Al, Mg, Ti, Zr, and a rare earth element may also be adhered to the surface of the positive electrode plate. Accordingly, even if the potential of the positive electrode is set to a high potential, the degradation of cycle characteristics can be further suppressed.

As the compound containing at least one element selected from W, Al, Mg, Ti, Zr, and a rare earth element, for example, a hydroxide, an oxyhydroxide, an oxide, a lithium compound, a phosphate compound, a fluoride, or a carbonate compound, each of which contains at least one element mentioned above, may be used, and for example, in order to further suppress the decomposition reaction of the electrolyte solution, a hydroxide, a phosphate compound, or a fluoride is preferable.

Among W, Al, Mg, Ti, Zr, and a rare earth element, for example, in order to further suppress the decomposition reaction of the electrolyte solution, W or a rare earth element is preferable.

As the rare earth element, for example, there may be mentioned yttrium, scandium, lanthanum, cerium, praseodymium, neodymium, samarium, europium, gadolinium, terbium, dysprosium, holmium, erbium, thulium, ytterbium, lutetium, or scandium, and among those mentioned above, for example, in order to effectively suppress the decomposition reaction of the electrolyte solution, lanthanum, neodymium, samarium, or erbium is preferable since an adhered substance thereof is finely dispersed. As the rare earth element, a plurality of elements may also be used in combination.

As the positive electrode active material, for example, a lithium transition metal composite oxide may be used, and in particular, a lithium composite oxide of Ni—Co—Mn and a lithium composite oxide of Ni—Co—Al are preferable in view of a high capacity and high input/output characteristics. As other examples, a lithium cobaltate, a lithium composite oxide of Ni—Mn—Al, an olivine type transition metal oxide (represented by LiMPO₄, M is selected from Fe, Mn, Co, and Ni) containing iron, manganese, or the like may be mentioned by way of example. In addition, those compounds mentioned above may be used alone or in combination. In addition, in the above lithium transition metal composite oxide, a substance, such as Al, Mg, Ti, Zr, W, and/or Bi may be solid-soluted. In addition, in the case in which positive electrode active materials belonging to the same type are only used, or in the case in which different types of positive electrode active materials are used in combination, as the positive electrode active materials, materials having the same particle diameter may be used, or materials having different particle diameters may also be used.

In addition, as the lithium composite oxide of Ni—Co—Mn, an oxide having a known composition, such as an oxide having a molar ratio among Ni, Co, and Mn of 5:3:2, 6:2:2, 7:1:2, 7:2:1, or 8:1:1 besides a molar ratio of 1:1:1, may be used. In particular, an oxide having a higher rate of Ni or Co than that of Mn is preferably used so as to increase the positive electrode capacity, and the difference in molar rate between Ni and Mn with respect to the total moles of Ni, Co, and Mn is preferably 0.05% or more.

The electrically conductive agent is for example, a powder or particles having an electrical conductivity and is used to enhance the electron conductivity of the positive electrode mixture layer. As the electrically conductive agent, a carbon material, a metal powder, and an organic material, each of which has an electrically conductivity, may be mentioned by way of example. In particular, for example, there may be mentioned acetylene black, ketjen black, and graphite as the carbon material; aluminum as the metal powder; potassium titanate and titanium oxide as the metal oxide; and a phenylene derivative as the organic material. Those electrically conductive agents may be used alone or at least two types thereof may be used in combination.

The binder is for example, a particulate polymer or a polymer having a network structure and is used to maintain a preferable contact state between a particulate positive electrode active material and a powdered or a particulate electrically conductive agent and to enhance the binding properties of the positive electrode active material and the like to the surface of the positive electrode collector. As the binder, a fluorinated polymer and a rubber-based polymer may be mentioned by way of example. In particular, for example, there may be mentioned a polytetrafluoroethylene (PTFE), a poly(vinylidene fluoride) (PVdF), or a modified polymer thereof as the fluorinated polymer; and an ethylene-propylene-isoprene copolymer or an ethylene-propylene-butadiene copolymer as the rubber-based polymer. The binder may be used in combination with a thickening agent such as a carboxymethyl cellulose (CMC) or a poly(ethylene oxide) (PEO).

As the positive electrode collector, for example, foil of a metal stable in a potential range of the positive electrode or a film having a surface layer on which a metal stable in a potential range of the positive electrode is arranged may be mentioned by way of example. As the metal stable in a potential range of the positive electrode, aluminum is preferably used.

The positive electrode for a nonaqueous electrolyte secondary battery according to this embodiment may be obtained, for example, by a method of dipping a positive electrode plate in which a positive electrode mixture layer containing a positive electrode active material which occludes and releases Li, a binder, and an electrically conductive agent is formed on a positive electrode collector in a solution containing at least one element selected from W, Al, Mg, Ti, Zr, and a rare earth element or by a method of spraying the above solution to the positive electrode plate. By the method described above, the positive electrode plate is brought into contact with the solution, and hence, a compound containing at least one element selected from W, Al, Mg, Ti, Zr, and a rare earth element can be adhered to all the surfaces of at least a part of the positive electrode active material, at least a part of the binder, and at least a part of the electrically conductive agent, each of which is contained in the positive electrode mixture layer. As a result, the positive electrode can contain the compound described above on the surface of the positive electrode plate and in the inside thereof.

After a positive electrode mixture slurry is formed on the positive electrode collector, is then dried, and is further rolled, the rolled positive electrode plate is preferably brought into contact with the solution described above. The reason for this is that even on a newly formed surface caused by breakage (crack) generated from an active material secondary particle surface during rolling, the compound of a rare earth element or the like can be made present.

### [Negative Electrode]

As the negative electrode, a negative electrode which has been used in the past may be used, and for example, a negative electrode may be obtained in such a way that after a negative electrode active material and a binder are mixed with water or an appropriate solvent, this mixture is applied to a negative electrode collector, is then dried, and is further rolled. As the negative electrode active material, for example, there may be mentioned a carbon material capable of occluding and releasing lithium, a metal capable of forming an alloy with lithium, or an alloy compound containing the metal mentioned above.

As the carbon material, for example, graphite, such as natural graphite, hardly graphitizable carbon, or artificial graphite, and cokes may be mentioned. As the alloy compound, a compound containing at least one type of metal capable of forming an alloy with lithium may be mentioned. As the metal capable of forming an alloy with lithium, silicon and tin may be mentioned by way of example, and a silicon oxide and a tin oxide, each of which is formed from the above metal and oxygen bonded thereto, may also be used. In addition, a mixture formed by mixing the above carbon material with a compound of silicon or tin may also be used.

As the negative electrode active material, besides the compounds described above, although the energy density may be decreased in some cases, a compound, such as lithium titanate, having a higher potential of charge/discharge with respect to metal lithium than that of a carbon material or the like may also be used.

As the negative electrode active material, besides the above silicon and the above silicon alloy, a silicon oxide [SiOₓ (0<x<2, in particular, 0<x<1 is preferable)] may also be used. In the silicon described above, silicon in a silicon oxide represented by SiOₓ (0<x<2) (SiOₓ=(Si)_{1-1/2x}+(SiO₂)_{1/2x}) may also be included.

As the binder, as in the case of the positive electrode, although a fluorinated polymer and a rubber-based polymer may be mentioned by way of example, a styrene-butadiene copolymer (SBR), which is a rubber-based polymer, a modified polymer thereof, or the like is preferably used. The binder may be used in combination with a thickening agent, such as a carboxymethyl cellulose (CMC).

For the negative electrode collector, for example, metal foil hardly forming an alloy with lithium in a potential range of the negative electrode or a film having a surface layer on which a metal hardly forming an alloy with lithium in a potential range of the negative electrode is arranged may be used. As the metal hardly forming an alloy with lithium in a potential range of the negative electrode, copper, which is inexpensive, which is easily machined, and which has a good electron conductivity, is preferably used.

### [Nonaqueous Electrolyte]

As a solvent of the nonaqueous electrolyte, a solvent which has been used in the past may be used. For example, there may be used a cyclic carbonate, such as ethylene carbonate, propylene carbonate, butylene carbonate, or butylene carbonate; a chain carbonate, such as dimethyl carbonate, methyl ethyl carbonate, or diethyl carbonate; a compound containing an ester, such as methyl acetate, ethyl acetate, propyl acetate, methyl propionate, ethyl propionate, or γ-butyrolactone; a compound containing a sulfone group, such as propanesultone; a compound containing an ether, such as 1,2-dimethoxyethane, 1,2-diethoxyethane, tetrahydrofuran, 1,3-dioxane, 1,4-dioxane, or 2-methyltetrahydrofuran; a compound containing a nitrile, such as butyronitrile, valeronitrile, n-heptanenitrile, succinonitrile, glutaronitrile, adiponitrile, pimelonitrile, 1,2,3-propanetricarbonitrile, or 1,3,5-pentanetricarbonitrile; or a compound containing an amide, such as dimethylformamide. In particular, a solvent in which some H of the compound mentioned above is substituted by F is preferably used. Those compounds may be used alone, or at least two thereof may be used in combination. In addition, in particular, a solvent using a cyclic carbonate and a chain carbonate in combination is preferably used, and a solvent in which a small amount of a compound containing a nitrile or a compound containing an ether is further used in combination with the solvent described above is preferable.

In addition, as a solute of the nonaqueous electrolyte, a solute which has been used in the past may be used, and for example, besides LiPF₆, LiBF₄, LiN(SO₂F)₂, LiN(SO₂CF₃)₂, LiN(SO₂C₂F₅)₂, LiPF₆₋ₓ(CₙF₂ₙ₋₁)ₓ (in the formula, 1<x<6, and n indicates 1 or 2), and the like, for example, a lithium salt using an oxalato complex as an anion or a salt such as LiPF₂O may be mentioned.

As the lithium salt using an oxalato complex as an anion, besides LiBOB (lithium-bisoxalate borate), there may be used a lithium salt having an anion in which C₂O₄²⁻ is coordinated at a central atom, such as Li[M(C₂O₄)ₓR_{y}](in the formula, M represents a transition metal or an element selected from the groups IIIb, IVb, and Vb of the Periodic Table; R represents a group selected from a halogen, an alkyl group, and a halogenated alkyl group: x represents a positive integer; and y represents 0 or a positive integer). In particular, Li[B(C₂O₄)F₂], Li[P(C₂O₄)F₄], and Li[P(C₂O₄)₂F₂] may be mentioned by way of example. Among those compound mentioned above, in order to form a stable coating film on the surface of the negative electrode even in a high-temperature environment, LiBOB is most preferably used.

Incidentally, the above solutes may be used alone, or at least two types thereof may be used in combination. In addition, although the concentration of the solute is not particularly limited, approximately 0.8 to 1.7 moles per one liter of the electrolyte solution is preferable.

### [Separator]

As the separator, a separator which has been used in the past may be used. As the separator, in particular, besides a separator containing a polyethylene, for example, there may be mentioned a separator in which a layer containing a polypropylene is formed on a surface of a polyethylene layer and a separator formed of a polyethylene having a surface to which for example, a resin, such as an aramid resin, is applied. In addition, a separator having a surface to which an inorganic filler, such as an oxide of titanium or aluminum, is adhered may also be used.

At least one of the interface between the positive electrode and the separator and the interface between the negative electrode and the separator, a layer (filler layer) containing an inorganic filler, which has been used in the past, may be formed. As the filler, an oxide or a phosphate compound containing at least one of titanium, aluminum, silicon, magnesium, and the like, which have been used in the past, may be mentioned, and a filler having a surface processed with a hydroxide or the like may also be mentioned.

As a method for forming the above filler layer, for example, there may be mentioned a method in which a filler-containing slurry is directly applied to the positive electrode, the negative electrode, or the separator and a method in which a sheet formed from a filler is adhered to the positive electrode, the negative electrode, or the separator.

### EXPERIMENTAL EXAMPLES

Hereinafter, with reference to experimental examples of the embodiment of the present invention, the present invention will be particularly described in more detail. However, the present invention is not limited to the following experimental examples and may be appropriately changed and modified without departing from the scope thereof.

### Experimental Example 1

### Formation of Positive Electrode

Li₂CO₃ and a co-precipitated oxide represented by Ni_{0.50}Co_{0.20}Mn_{0.30}(OH)₂ were mixed together using an Ishikawa-type grinding mortar so that a molar ratio of Li to the whole transition metal was 1.08 to 1. Next, this mixture was heat-treated in an air atmosphere at 950° C. for 20 hours and was then pulverized, so that a lithium nickel cobalt manganate having an average secondary particle diameter of approximately 15 μm and represented by Li_{1.08}Ni_{0.50}Co_{0.20}Mn_{0.30}O₂ was obtained.

To this lithium nickel cobalt manganate thus obtained as a positive electrode active material, carbon black as an electrically conductive agent, a poly(vinylidene fluoride) (PVdF) as a binder, and N-methyl-2-pyrrolidone as a dispersant were added to have a mass ratio of the positive electrode, the electrically conductive agent, and the binder of 95:2.5:2.5 and were then kneaded together, so that a positive electrode slurry was prepared. Subsequently, after this positive electrode slurry was applied to two surfaces of a positive electrode collector formed of aluminum foil and was then dried, rolling was performed using rolling rollers, so that the packing density of a positive electrode was set to 3.2 g/cc. Furthermore, a positive electrode collector tab was fitted, so that a positive electrode in which positive electrode mixture layers were formed on the two surfaces of the positive electrode collector was obtained.

The positive electrode plate described above was dipped in a sodium tungstate aqueous solution at a concentration of 0.03 mol/L and was then dried in the air at 110° C., so that a positive electrode plate containing a tungsten compound in the inside and on the surface thereof was formed.

According to the result of ICP analysis using an ICP emission spectroscopic analysis apparatus, on the surface of the positive electrode plate thus obtained and in the inside thereof, 0.20 percent by mass of the tungsten compound on the tungsten element basis was contained. In addition, according to the result obtained by observation of the surface and the cross-section of the positive electrode plate using a scanning electron microscope (SEM), it was confirmed that a 0.5-μm thick layer of the tungsten compound (mostly sodium tungstate) was formed on a part of the surface of the electrode plate. In addition, the tungsten compound was adhered not only to a part of the surface of the positive electrode active material but also to a part of the surface of the electrically conductive agent and a part of the surface of the binder. In addition, it was confirmed that breakage (crack) was generated in a positive electrode active material secondary particle at a rate of approximately one to six particles, and that the tungsten compound was adhered to a newly formed surface (crack surface) generated by the breakage.

### [Formation of Negative Electrode]

To an aqueous solution in which a CMC (carboxymethyl cellulose) as a thickening agent was dissolved in water, artificial graphite as a negative electrode active material and a SBR (styrene-butadiene rubber) as a binder were added to have a mass ratio of the negative electrode active material, the binder, and the thickening agent of 98:1:1 and were then kneaded, so that a negative electrode slurry was formed. After this negative electrode slurry was applied as uniform as possible to two surfaces of a negative electrode collector formed of copper foil, was then dried, and was further rolled with rolling rollers, a negative electrode collector tab was fitted, so that a negative electrode was formed.

### [Preparation of Nonaqueous Electrolyte]

In a mixed solvent obtained by mixing ethylene carbonate (EC), methyl ethyl carbonate (MEC), and diethyl carbonate (DEC) at a volume ratio of 3:6:1, lithium hexafluorophosphate (LiPF₆) was dissolved so as to have a concentration of 1.2 mol/liter. Furthermore, 2.0 percent by mass of vinylene carbonate (VC) was added with respect to the total nonaqueous electrolyte and was then dissolved, so that a nonaqueous electrolyte was prepared.

### [Formation of Battery]

After the positive electrode and the negative electrode obtained as described above were wound to face each other with at least one separator interposed therebetween so as to form a wound body, this wound body was sealed with an aluminum laminate together with the nonaqueous electrolyte in a glow box in an argon atmosphere, so that a nonaqueous electrolyte secondary battery A1 having a thickness of 3.6 mm, a width of 3.5 cm, and a length of 6.2 cm was formed.

### Experimental Example 2

Except that as the solution used when the positive electrode was dipped, an erbium acetate aqueous solution at a concentration of 0.03 mol/liter was used instead of the sodium tungstate aqueous solution, a nonaqueous electrolyte secondary battery A2 was formed in a manner similar to that of the above Experimental Example 1.

According to the result of ICP analysis using an ICP emission spectroscopic analysis apparatus, on the surface of the positive electrode plate thus obtained and in the inside thereof, 0.20 percent by mass of an erbium compound on the erbium element basis was contained. In addition, according to the result obtained by observation of the surface and the cross-section of the positive electrode plate using a scanning electron microscope (SEM), it was confirmed that a 0.5-μm thick layer of the erbium compound (mostly erbium hydroxide) was formed on a part of the surface of the electrode plate. In addition, the erbium compound was adhered not only to a part of the surface of the positive electrode active material but also to a part of the surface of the electrically conductive agent and a part of the surface of the binder. In addition, it was confirmed that breakage (crack) was generated in a positive electrode active material secondary particle at a rate of approximately one to six particles, and that the erbium compound was adhered to a newly formed surface (crack surface) generated by the breakage.

### Experimental Example 3

Except that the positive electrode was not dipped in the sodium tungstate solution, a nonaqueous electrolyte secondary battery A3 was formed in a manner similar to that of the above Experimental Example 1.

### Experimental Example 4

While the powdered lithium nickel cobalt manganate used in Experimental Example 1 was mixed by a mixing machine (TK HIVIS MIX, manufactured by PRIMIX Corp.), a solution in which sodium tungstate was dissolved in purified water (0.51 mol/L) was sprayed. Next, drying was performed in the air at 120° C., so that a positive electrode active material in which sodium tungstate was adhered to a part of the surface of the above lithium nickel cobalt manganate was obtained.

It was confirmed that by observation of the positive electrode active material thus obtained using a scanning electron microscope (SEM), a sodium tungstate having an average particle diameter of 0.5 nm or less was adhered to a part of the surface of each lithium nickel cobalt manganate particle. In addition, investigation was performed by ICP analysis, and it was found that the amount of the sodium tungstate adhered to the lithium nickel cobalt manganate particle was 1.7 percent by mass on the tungsten element basis.

Except that as the positive electrode active material, this positive electrode active material, which had a surface to which the tungsten compound (mostly sodium tungstate) was adhered, was used, a nonaqueous electrolyte secondary battery A4 was formed in a manner similar to that of the above Experimental Example 1. In addition, by SEM observation of the surface and the cross-section of the positive electrode performed before the battery formation, a layer of the tungsten compound was not formed on the surface of the electrode plate. In addition, although breakage (crack) was generated in an active material secondary particle at a rate of approximately one to six particles, the tungsten compound was not adhered to a newly formed surface generated by the breakage.

### Experimental Example 5

Except that a solution in which erbium acetate tetrahydrate was dissolved in purified water (0.12 mol/L) was used instead of using sodium tungstate, a positive electrode active material was obtained in a manner similar to that of Experimental Example 4.

It was confirmed that by observation of the positive electrode active material thus obtained using a scanning electron microscope (SEM), an erbium compound having an average particle diameter of 10 nm was adhered to a part of the surface of each lithium nickel cobalt manganate particle. In addition, by measurement of the adhesion amount of the erbium compound by ICP, the amount was 0.20 percent by mass with respect to the lithium nickel cobalt manganate on the erbium element basis. In addition, the erbium compound after a heat treatment was mostly erbium hydroxide.

Except that as the positive electrode active material, this positive electrode active material, which had a surface to which the erbium compound (mostly erbium hydroxide) was adhered, was used, a nonaqueous electrolyte secondary battery A5 was formed in a manner similar to that of the above Experimental Example 1. In addition, by SEM observation of the surface and the cross-section of the positive electrode performed before the battery formation, a layer of the erbium compound was not formed on the surface of the electrode plate. In addition, although breakage (crack) was generated in an active material secondary particle at a rate of approximately one to six particles, the erbium compound was not adhered to a newly formed surface generated by the breakage.

### [Experiment 1]

Charge/discharge was performed on each of the above batteries A1 to A5 under the following conditions, and cycle characteristics obtained when the potential of the positive electrode was set to a high potential were evaluated.

### [Charge/Discharge Conditions at First Cycle]

Charge Conditions at First Cycle

Constant current charge was performed at a current of 640 mA until the battery voltage reached 4.35 V, and constant voltage charge was further performed at a constant voltage of 4.35 V until the current reached 32 mA.

Discharge Conditions at First Cycle

Constant current discharge was performed at a constant current of 800 mA until the battery voltage reached 3.00 V. The discharge capacity at this cycle was measured and regarded as an initial discharge capacity.

Rest

A rest interval between the charge and the discharge described above was set to 10 minutes.

A charge/discharge cycle test was performed 250 times under the conditions described above, and a discharge capacity after 250 cycles was measured. The capacity retention rate after 250 cycles was calculated by the following equation. The results thereof are shown in the following Table 1.

Capacity retention rate after 250 cycles [%]=(Discharge capacity after 250 cycles÷Initial discharge capacity)×100

TABLE 1

| | | | Capacity |
|---|---|---|---|
| | | | retention |
| | Battery | Type of adhesion element | rate [%] |
| Experimental | A1 | W compound adhered to positive | 78 |
| Example 1 | | electrode active material, electrically | |
| | | conductive agent, and binder | |
| Experimental | A2 | Er compound adhered to positive | 78 |
| Example 2 | | electrode active material, electrically | |
| | | conductive agent, and binder | |
| Experimental | A3 | None | 52 |
| Example 3 | | | |
| Experimental | A4 | W compound adhered only to posi- | 73 |
| Example 4 | | tive electrode active material | |
| Experimental | A5 | Er compound adhered only to posi- | 73 |
| Example 5 | | tive electrode active material | |

As apparent from the results shown in the above Table 1, in the batteries A1 and A2 in which the lithium nickel cobalt manganate was used as the positive electrode active material, and the tungsten compound or the erbium compound was adhered not only to a part of the positive electrode active material but also to parts of the electrically conductive agent and the binder, the cycle characteristics obtained when the potential of the positive electrode was set to a high potential was significantly improved as compared to those of the battery A3 in which no tungsten compound nor the erbium compound was adhered and to those of each of the batteries A4 and A5 in which the tungsten compound or the erbium compound was adhered only to the positive electrode active material.

It has been believed that the transition metal contained in the positive electrode active material has catalytic properties; in the positive electrode and on the surface thereof, a catalytic effect is also generated even at the surfaces of the electrically conductive agent and the binder which are present on the surface of the positive electrode active material; and a decomposition reaction of the electrolyte solution is generated. Hence, as Experimental Examples 1 and 2, when the tungsten compound or the rare earth compound was adhered to the electrically conductive agent and the binder as well as to the positive electrode active material, the cycle characteristics obtained when the potential of the positive electrode was set to a high potential were improved. In addition, it is also believed that since the tungsten compound or the rare earth compound was present on the newly formed surface generated by breakage of the secondary particle during rolling of the positive electrode, the decomposition reaction of the electrolyte solution at the surface could be further suppressed.

In addition, it is also believed that in Experimental Examples 4 and 5, since no tungsten compound nor rare earth compound was present on the newly formed surface generated by breakage of the active material secondary particle during rolling of the positive electrode, at the newly formed surface generated by the breakage of the active material secondary particle during the rolling, the decomposition reaction of the electrolyte solution was generated.

### Experimental Example 6

Except that in Experimental Example 1, lithium cobaltate was used as the positive electrode active material instead of using the lithium nickel cobalt manganate, and the packing density of the positive electrode was set to 3.6 g/cc, a nonaqueous electrolyte secondary battery A6 was formed in a manner similar to that of the above Experimental Example 1. According to the result of ICP analysis using an ICP emission spectroscopic analysis apparatus, on the surface of the positive electrode plate thus obtained and in the inside thereof, 0.20 percent by mass of a tungsten compound on the tungsten element basis was contained. In addition, according to the result obtained by observation of the surface and the cross-section of the positive electrode plate using a scanning electron microscope (SEM), it was confirmed that a 0.5-μm thick layer of the tungsten compound (mostly sodium tungstate) was formed on a part of the surface of the electrode plate. In addition, the tungsten compound was adhered not only to a part of the surface of the positive electrode active material but also to a part of the surface of the electrically conductive agent and a part of the surface of the binder. In addition, it was confirmed that breakage (crack) was generated in a positive electrode active material secondary particle at a rate of approximately one to ten particles, and that the tungsten compound was adhered to a newly formed surface (crack surface) generated by the breakage.

### Experimental Example 7

Except that the positive electrode was not dipped in the sodium tungstate solution, a nonaqueous electrolyte secondary battery A7 was formed in a manner similar to that of the above Experimental Example 6.

### [Experiment 2]

Charge/discharge was performed on each of the above batteries A6 and A7 under the following conditions, and cycle characteristics obtained when the potential of the positive electrode was set to a high potential were evaluated.

### [Charge/Discharge Conditions at First Cycle]

Charge Conditions at First Cycle

Constant current charge was performed at a current of 750 mA until the battery voltage reached 4.40 V, and constant voltage charge was further performed at a constant voltage of 4.40 until the current reached 38 mA.

Discharge Conditions at First Cycle

Constant current discharge was performed at a constant current of 750 mA until the battery voltage reached 2.75. The discharge capacity at this cycle was measured and regarded as an initial discharge capacity.

Rest

A rest interval between the charge and the discharge described above was set to 10 minutes.

A charge/discharge cycle test was performed 150 times under the conditions described above, and a discharge capacity after 150 cycles was measured. The capacity retention rate after 150 cycles was calculated by the following equation. The results are shown in the following Table 2.

Capacity retention rate after 150 cycles [%]=(Discharge capacity after 150 cycles÷Initial discharge capacity)×100

TABLE 2

| | | | Capacity |
|---|---|---|---|
| | | | retention |
| | Battery | Type of adhesion element | rate (%) |
| Experimental | A6 | W compound adhered to positive | 92 |
| Example 6 | | electrode active material, electrically | |
| | | conductive agent, and binder | |
| Experimental | A7 | None | 87 |
| Example 7 | | | |

As apparent from the results shown in the above Table 2, in the battery A6 in which lithium cobaltate was used as the positive electrode active material, and the tungsten compound was adhered not only to a part of the positive electrode active material but also to parts of the electrically conductive agent and the binder, the cycle characteristics obtained when the potential of the positive electrode was set to a high potential were also improved as compared to those of the battery A7 in which the tungsten compound was not adhered.

### Experimental Example 8

### Formation of Positive Electrode Active Material (Lithium Nickel Cobalt Aluminate)

A nickel cobalt aluminum composite hydroxide obtained by co-precipitation and represented by Ni_{0.82}Co_{0.15}Al_{0.03}(OH)₂ was formed into an oxide at 600° C. Next, LiOH and the nickel cobalt aluminum composite oxide thus obtained were mixed by an Ishikawa-type grinding mortar so that a molar ratio of Li to the whole transition metal was 1.05:1, and this mixture was heat-treated in an oxygen atmosphere at 800° C. for 20 hours and was then pulverized, so that particles of a lithium nickel cobalt aluminate represented by Li_{1.05}Ni_{0.82}Co_{0.15}Al_{0.03}O₂ and having an average secondary particle diameter of approximately 15 μm were obtained.

After 1,000 g of particles of the lithium nickel cobalt aluminate thus obtained were charged in 1.5 L of purified water and stirred (washed), vacuum drying was performed, so that a lithium nickel cobalt aluminate powder was obtained.

Except that the lithium nickel cobalt aluminate (Li_{1.05}Ni_{0.82}Co_{0.15}Al_{0.03}O₂) formed as described above was used as the positive electrode active material instead of using lithium nickel cobalt manganate, and the packing density of the positive electrode was set to 3.6 g/cc, a nonaqueous electrolyte secondary battery A8 was formed in a manner similar to that of the above Experimental Example 1. According to the result of ICP analysis using an ICP emission spectroscopic analysis apparatus, on the surface of the positive electrode plate obtained before the battery formation and in the inside thereof, 0.20 percent by mass of a tungsten compound on the tungsten element basis was contained. In addition, according to the result obtained by observation of the surface and the cross-section of the positive electrode plate using a scanning electron microscope (SEM), it was confirmed that a 0.5-μm thick layer of the tungsten compound (mostly sodium tungstate) was formed on a part of the surface of the electrode plate. In addition, the tungsten compound was adhered not only to a part of the surface of the positive electrode active material but also to a part of the surface of the electrically conductive agent and a part of the surface of the binder. In addition, it was confirmed that breakage (crack) was generated in a positive electrode active material secondary particle at a rate of approximately one to four particles, and that the tungsten compound was adhered to a newly formed surface (crack surface) generated by the breakage.

### Experimental Example 9

Except that an erbium acetate aqueous solution at a concentration of 0.03 mol/liter was used as the solution used when the positive electrode was dipped instead of the sodium tungstate aqueous solution, a nonaqueous electrolyte secondary battery A9 was formed in a manner similar to that of the above Experimental Example 8. According to the result of ICP analysis using an ICP emission spectroscopic analysis apparatus, on the surface of the positive electrode plate obtained before the battery formation and in the inside thereof, 0.20 percent by mass of an erbium compound on the erbium element basis was contained. In addition, according to the result obtained by observation of the surface and the cross-section of the positive electrode plate using a scanning electron microscope (SEM), it was confirmed that a 0.5-μm thick layer of the erbium compound (mostly erbium hydroxide) was formed on a part of the surface of the electrode plate. In addition, the erbium compound was adhered not only to a part of the surface of the positive electrode active material but also to a part of the surface of the electrically conductive agent and a part of the surface of the binder. In addition, it was confirmed that breakage (crack) was generated in a positive electrode active material secondary particle at a rate of approximately one to four particles, and that the erbium compound was adhered to a newly formed surface (crack surface) generated by the breakage.

### Experimental Example 10

Except that the positive electrode was not dipped in the sodium tungstate solution, a nonaqueous electrolyte secondary battery A10 was formed in a manner similar to that of the above Experimental Example 8.

### [Experiment 3]

Charge/discharge was performed on each of the above batteries A8 to A10 under the following conditions, and cycle characteristics obtained when the potential of the positive electrode was set to a high potential were evaluated.

### [Charge/Discharge Conditions at First Cycle]

Charge Conditions at First Cycle

Constant current charge was performed at a current of 475 mA until the battery voltage reached 4.40 V, and constant voltage charge was further performed at a constant voltage of 4.40 until the current reached 38 mA.

Discharge Conditions at First Cycle

Constant current discharge was performed at a constant current of 950 mA until the battery voltage reached 2.50. The discharge capacity at this cycle was measured and regarded as an initial discharge capacity.

Rest

A rest interval between the charge and the discharge described above was set to 10 minutes.

A charge/discharge cycle test was performed 100 times under the conditions described above, and a discharge capacity after 100 cycles was measured. The capacity retention rate after 100 cycles was calculated by the following equation. The results are shown in the following Table 3.

Capacity retention rate after 100 cycles [%]=(Discharge capacity after 100 cycles÷Initial discharge capacity)×100

TABLE 3

| | | | Capacity |
|---|---|---|---|
| | | | retention |
| | | Type of adhesion element | rate (%) |
| Experimental | A 8 | W compound adhered to positive | 85 |
| Example 8 | | electrode active material, electrically | |
| | | conductive agent, and binder | |
| Experimental | A 9 | Er compound adhered to positive | 84 |
| Example 9 | | electrode active material, electrically | |
| | | conductive agent, and binder | |
| Experimental | A 10 | None | 80 |
| Example 10 | | | |

As apparent from the results shown in the above Table 3, even in the case in which the lithium nickel cobalt aluminate was used as the positive electrode active material, in the batteries A8 and A9 in each of which the tungsten compound or the erbium compound was adhered not only to a part of the positive electrode active material but also to parts of the electrically conductive agent and the binder, the cycle characteristics obtained when the potential of the positive electrode was set to a high potential were improved as compared to those of the battery A10 in which no tungsten compound nor erbium compound was adhered.

In addition, in the lithium nickel cobalt aluminate which was not processed by a water washing treatment, the amount of a remaining alkali measured by a Warder method was approximately 50 times that of a lithium nickel cobalt aluminate which was processed by a water washing treatment, and furthermore, the amount of a gas generation obtained when the battery was stored at 80° C. for 48 hours was 3 times or more. Hence, in order to obtain high-temperature storage characteristics, the lithium nickel cobalt aluminate thus obtained is preferably processed by a water washing treatment using an appropriate amount of water so as to remove an alkali component adhered to the surface of the lithium nickel cobalt aluminate.

1. A positive electrode for a nonaqueous electrolyte secondary battery, the positive electrode comprising: a positive electrode plate in which a positive electrode mixture layer containing a positive electrode active material which occludes and releases Li, a binder, and an electrically conductive agent is formed on a positive electrode collector,
wherein a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

2. The positive electrode for a nonaqueous electrolyte secondary battery according to claim 1,
wherein the compound containing at least one element selected from W, Al, Mg, Ti, Zr, and a rare earth element is adhered to a crack surface of a secondary particle of the positive electrode active material.

3. The positive electrode for a nonaqueous electrolyte secondary battery according to claim 1,
wherein the element is at least one element selected from W and a rare earth element.

4. The positive electrode for a nonaqueous electrolyte secondary battery according to claim 1,
wherein the compound containing at least one element is also adhered to the surface of the positive electrode plate.

5. A method for manufacturing a positive electrode for a nonaqueous electrolyte secondary battery, the method comprising: bringing a positive electrode plate in which a positive electrode mixture layer containing a positive electrode active material which occludes and releases Li, a binder, and an electrically conductive agent is formed on a positive electrode collector into contact with a solution containing at least one element selected from W, Al, Mg, Ti, Zr, and a rare earth element so that a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

6. A nonaqueous electrolyte secondary battery comprising: a positive electrode; a negative electrode; and a nonaqueous electrolyte,
wherein the positive electrode includes a positive electrode plate in which a positive electrode mixture layer containing a positive electrode active material which occludes and releases Li, a binder, and an electrically conductive agent is formed on a positive electrode collector, and
a compound containing at least one element selected from W, Al, Mg, Ti, Zr, and a rare earth element is adhered to all the surfaces of at least a part of the positive electrode active material, at least a part of the binder, and at least a part of the electrically conductive agent, each of which is contained in the positive electrode mixture layer.

7. The positive electrode for a nonaqueous electrolyte secondary battery according to claim 2,
wherein the element is at least one element selected from W and a rare earth element.

8. The positive electrode for a nonaqueous electrolyte secondary battery according to claim 2,
wherein the compound containing at least one element is also adhered to the surface of the positive electrode plate.

9. The positive electrode for a nonaqueous electrolyte secondary battery according to claim 3,
wherein the compound containing at least one element is also adhered to the surface of the positive electrode plate.
